(19) United States
(12) Patent Application Publication
(10) Pub. No.: US 2002/0095679 A1
(43) Pub. Date: Jul. 18, 2002

(54) Method and system providing a digital cinema distribution network having backchannel feedback

(76) Inventor: Robert Nathaniel Bonini, Brooklyn, NY (US)

Correspondence Address: Paul D. Greeley, Esq., Ohlandt, Greeley, Ruggiero & Perle, L.L.P., 10 Floor, One Landmark Square, Stamford, CT, 06901-2682, US

(21) Appl. No.: 10/052,915

(22) Filed: Jan. 18, 2002

Related U.S. Application Data
(60) Provisional application No. 60/262,608, filed on Jan. 18, 2001.

(51) Int. Cl. H04N 7/18; H04N 7/173

(52) U.S. Cl. 725/74; 725/78; 725/105; 725/93

(57) ABSTRACT

In one aspect this invention provides a digital content distribution and viewing system that includes a source of at least one of pre-recorded or live digital content; a transport mechanism for distributing the digital content to a plurality of theater locations in combination with at least one script, where the theater locations enable the digital content to be viewed by an audience with theater equipment; at the theater locations, a store and forward server for receiving the digital content and the at least one script, and for executing the script for controlling actions of the theater equipment during the viewing of said digital content. A backchannel is provided for transporting to a central site a log that is descriptive of at least some of the actions, and an associated time stamp of when the action was performed. In another aspect the invention provides, at the plurality of theater locations, video cameras for generating live video of the audience for transport to one or more viewing locations. In yet a further aspect the backchannel transports audience generated input signals to one or more locations. The backchannel can be implemented using the Internet.

This application claims priority of U.S. provisional patent application No.: 60,262,608, filed on Jan. 18, 2001.

### BACKGROUND OF THE INVENTION

1. Field of the Invention

This invention relates to a digital distribution network system, and in particular to a method and a system for distributing digital video, audio, and data content.

2. Description of the Related Art

Digital cinema is changing the manner in which films can be captured, delivered and viewed. Digital cinema promises to transform the movie industry, as it will allow for the shooting, editing, and distribution of a film to be completed entirely electronically.

Currently, the distribution of digital content is hindered by several factors including, for example, costs of converting to digital cinema technology, the limited bandwidth of available transmission networks and the security of digitally transmitted content.

Notwithstanding these factors, the demand for digital cinema is increasing. This increasing demand for digital cinema can be attributed, in part, to the benefits of digital cinema, such as, cost savings in the production, processing, and distribution of content.

PCT Publication Number WO 99/66728 discloses a system and method for secure electronic delivery of motion pictures in digital format to many end users simultaneously. The system includes a studio-distributor management system, a headend system, a theater system, and a creator/editors system. Another example can be found in PCT Publication Number WO 00/34825. This publication is related more specifically to a control system for a multi-projection room cinema.

What is needed is a digital distribution system that provides an efficient and flexible means for taking advantage of the rapidly changing digital cinema technology.

### SUMMARY OF THE INVENTION

The teachings herein provide a digital distribution network (DDN) for the distribution of digital cinema content, including digital video, audio, and data, to end locations, typically digital cinemas or theaters. It is also within the scope of the teachings herein that the DDN distribute digital cinema content to home theaters, residences, PDAs, cell phones, and similar devices. The DDN described herein is flexible as it can be configured to provide the distribution of pre-recorded content, live content, video games, video conferencing, interactive content, and combinations thereof, in a variety of configurations. The DDN provides an end-to-end distribution system and method for digital content. The DDN also has an ability to control event scheduling, transmission of scheduling software, bi-directional teleconferencing for screenings and audience monitoring. The DDN can be remotely controlled and configured. Moreover, the operational status or health of the DDN, and each theater, may be remotely monitored and alarmed via a back channel that transmits information to a central location.

The DDN in accordance with these teachings furthermore provides a networked feedback mechanism, which may be wired or wireless, for audience monitoring. The DDN also includes an interface with a global data communications network for enabling theater viewers to interactively receive information concerning a scene being displayed, and for commenting on the DDN distributed films using, for example, web forums, chats, and email.

Furthermore, the DDN provides a secure network using encryption methods (e.g., IPSEC, NIST AES, and presently preferred 3 DES encryption techniques).

The transmission and event scheduling software is accessible via an internal Extranet.

In one aspect this invention provides a digital content distribution and viewing system that includes a source of at least one of pre-recorded or live digital content; a transport mechanism for distributing the digital content to a plurality of theater locations where the digital content can be viewed by an audience and, at the plurality of theater locations, video cameras for generating live video of the audience for transport to one or more viewing locations.

In another aspect this invention provides a digital content distribution and viewing system that includes a source of at least one of pre-recorded or live digital content; a transport mechanism for distributing the digital content to a plurality of theater locations where the digital content can be viewed by an audience; at the plurality of theater locations, audience input devices for generating audience input signals; and a backchannel for transporting the audience input signals to one or more locations. The backchannel can be implemented using any public or private telecommunications connection, including the Internet.

In a further aspect this invention provides a digital content distribution and viewing system that includes a source of at least one of pre-recorded or live digital content; a transport mechanism for distributing the digital content to a plurality of theater locations in combination with at least one script, where the theater locations enable the digital content to be viewed by an audience with theater equipment; at the theater locations, a store and forward server for receiving the digital content and the at least one script, and for executing the script for controlling actions of the theater equipment during the viewing of the digital content; and a backchannel for transporting to a central site a log that is descriptive of at least some of the actions and equipment capabilities, and an associated time stamp of when the action was performed.

In a still further aspect of this invention a digital content distribution and viewing system includes a source of at least one of pre-recorded or live digital content; a transport mechanism for distributing the digital content to a plurality of theater locations in a compressed, encrypted format using a first encryption technique, where the theater locations enable the digital content to be viewed by an audience with theater equipment; at the theater locations, a store and forward server for receiving said digital content, the store and forward server having an output coupled to an input of a digital projection system and operating to decompress and decrypt the digital content, and for encrypting the digital content using a second encryption technique before transmitting the digital content to the input of the digital projection system.

In yet another aspect, this invention provides an embodiment wherein there is interposed, between the output of the store and forward server and the digital projection system or inside the projection head, an interface module operable for decompressing and decrypting the digital content, and for encrypting the digital content using a second encryption technique before transmitting the digital content to the input of the digital projection system. In this latter embodiment the second encryption technique may include “light” encryption techniques such as data scrambling, and the interface module may include an MPEG codec. Fractal compression, wavelet compression, Multi-Layer DCT, and Adaptive Block Size DCT may also be used. It is also within the scope of the present invention that the transmitted audio and/or video be distributed in an uncompressed format.

### BRIEF DESCRIPTION OF THE DRAWINGS

FIG. 1 is an overall block diagram of an embodiment of the DDN of the present invention;

FIG. 2 is a block diagram depicting a satellite network transmission aspect of the DDN;

FIG. 3 is a block diagram of one embodiment of a DDN originating site for receiving input from a terrestrial network and a DDN satellite uplink;

FIG. 4 is a block diagram of a second embodiment of a DDN originating site having a satellite downlink and a DDN satellite uplink;

FIG. 5 is a block diagram depicting a first embodiment of a satellite network transmission and video conformance aspect of the DDN for the distribution of live events to both theaters and the DDN originating site for re-transmission on the network;

FIG. 6 is a block diagram depicting a further embodiment of a satellite network transmission aspect of the DDN for the conformance and distribution of live events to the DDN originating site for re-transmission on the network;

FIG. 7 is a block diagram of theater equipment and signal flow of the DDN of FIG. 1;

FIG. 8 is a block diagram of a teleconferencing configuration of the DDN of FIG. 1;

FIG. 9 is a block diagram illustrating an embodiment of the theater equipment configuration, including teleconferencing capabilities for the DDN;

FIG. 10 is an overall block diagram of the system architecture for the DDN of FIG. 1;

FIG. 11 depicts an exemplary film event script;

FIG. 12 depicts an exemplary live event script;

FIG. 13 is a block diagram of a further embodiment of this invention, wherein an interface unit is disposed between the store and forward server and the digital projection head; and

FIG. 14 is a high level block diagram showing a content data stream output from the store and forward server to the interface unit of FIG. 13, where the content includes embedded metadata for configuring the interface unit.

### DETAILED DESCRIPTION OF THE INVENTION

As employed herein an “action” refers to any command acted upon by theater equipment. For example, closing the auditorium curtains or displaying a still image for 30 seconds are both examples of an action. Certain actions are recorded in a log with an associated time stamp and provided through a backchannel to a central control site so as to enable, for example, the tracking of the unauthorized use of film content and/or the tracking of advertisements played for viewers. The word “content” refers to a smallest displayable entity, for example, a single still frame, piece of video, or a single file. An “event” is one of a plurality of defined uses for a DDN (Digital Distribution Network) 1, such as viewing pre-recorded video, viewing live events, or video teleconferencing. A “program” is a group of actions that form a portion of an event or all of an event. A “script” is a mechanism by which a program performs actions. A “theater server” or “video server”, also referred to herein as a “store and forward server” and a “store/forward server” is a hardware/software device that stores, schedules and makes content available for play. Decoder as used herein should be understood to include at least the functions of decoding video images and decoding signals from the network (satellite or otherwise) that are to be sent to the video decoder.

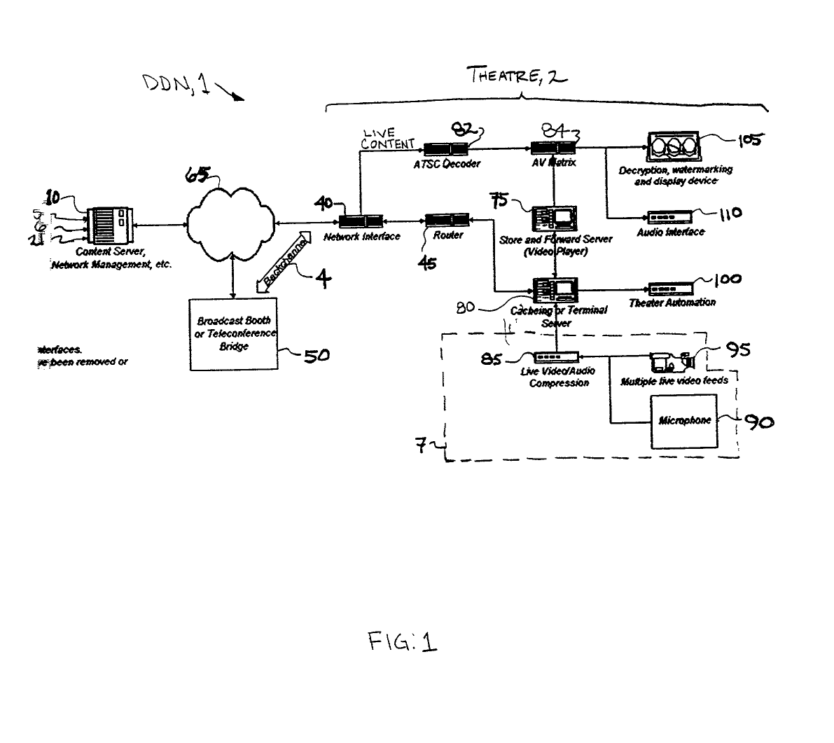

With general reference to the accompanying figures, and in particular to FIGS. 1, 7, 9 and 10, the overall system architecture of the DDN system 1 is described. DDN system 1 is referred to hereafter simply as the DDN 1. DDN 1 provides for the distribution of digital content, including video, audio, and data, to a plurality of theaters 2 from a content origination center 3 as well as from other sources. Other sources of content include, for example, a live feed source 6. The content can be any combination of video, audio, and data distributed as, for example, pre-recorded 5 or live content 6. A feature of the present invention is a capability for DDN 1 to provide bi-directional video teleconferencing between theater 2 using a live audio/video system 7 located at theater 2. The bi-directional teleconferencing content is routed to a broadcast booth 50 via a live video/audio compression system 85, a caching server 80, a data router 45 and a network interface 40. Network interface 40 can interface with a wireless (e.g., satellite) and/or a terrestrial network.

A backchannel 4 is provided and may be established, for example, via a return transponder link through a satellite and/or a wired or wireless terrestrial data communications network, such as a terrestrial communications network or the Internet. A combination of different paths and transport mechanisms may be employed in tandem to implement backchannel 4.

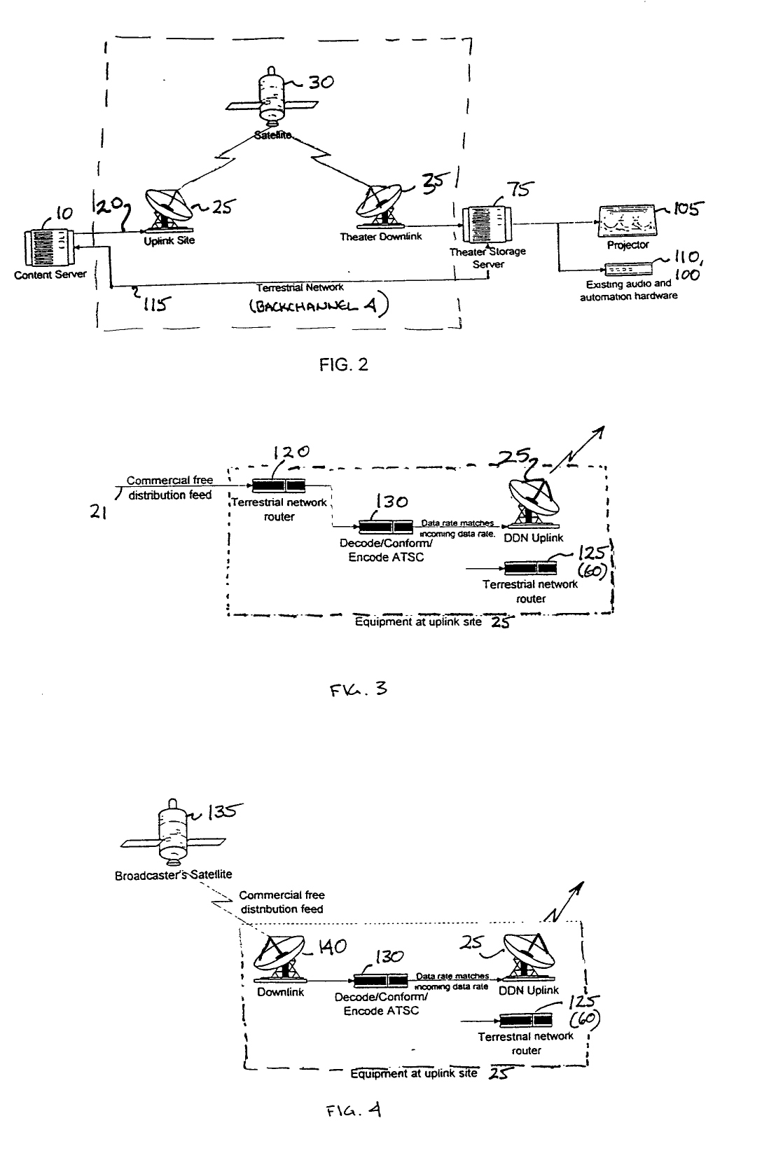

Content server 10 can accommodate live content 6 and pre-recorded content 5. A further input to the uplink site 25 can be optional third party content that is sent directly to the uplink site 25. Content server 10 may receive live 6 and/or pre-recorded 5 content data from a variety of content origination source locations. Content server 10 may be implemented as a component of a content transport system 65 that may include a satellite transponder 30 associated with an uplink site 25 and a plurality of downlink sites 35. Each of downlink sites 35 is preferably associated with a theater 2 (see FIGS. 2 -6). Content server 10 is coupled to uplink site 25 via an appropriate intra-network 20. Downlink site 35 located at the theater 2 may include a satellite dish located on a roof of theater 2. A terrestrial network router 45 enables the content to be delivered via a terrestrial data network to those theaters 2 that do not support a satellite receiver downlink site 35.

At theater 2, a network interface unit 40 receives the transmitted content via transport mechanism 65, demodulates the transmission, and provides a digital output to router 45. Router 45 is connected to a caching server 80 on a LAN that may include a type of mass storage system for storing transmitted content received from content server 10, broadcast booth 50, and/or the third party providing third party content 21. A caching server 80 is coupled to store and forward server 75 (hereinafter store/forward server 75) or provides the functionality of a store/forward server. Store and forward server 75 provides an output of the transmitted content to an audio playback system 110 via, for example, an AES link. Store and forward server 75 provides another output to a decryption and digital projection system 105 via an AV matrix 84. AV matrix 84 includes a digital projection system and may be any one of several commercially available digital projection systems. AV matrix 84 facilitates coupling multiple data content transmissions to projection system 105. Examples of suitable projection systems currently available include Texas Instruments Digital Light Processing™ (DPL) projectors, and Hughes-JVC's Direct-Drive Image Light Amplifier™ (D-ILA) projectors.

Caching server 80 (e.g., a PC) provides control, reporting, error logging, buffering and additional storage, if required. Caching server 80 directly, or store/forward server 75, provides a control output to a theater automation system 100. Theater automation system 100 is used for controlling theater lighting, a theater curtain (if present) and other automated theater controls, such as masking for different aspect ratios and lens changes. All of the functions controlled by theater automation system 100 are preferably coordinated by downloaded script files executed by store/forward server 75.

An aspect of these teachings is the ability to provide video and audio signals generated at theater 2 using one or more live video feeds 95 and microphones 90. The outputs of live video feeds 95 and microphones 90 are provided to a live video/audio compression system 85 that provides compressed video/audio signals to caching server 80. Caching server 80 in turn relays the compressed video/audio signals to terrestrial network router 45. From router 45 the live video/audio content can be transmitted to broadcast boot or telecommunications bridge 50. In this manner, and by example, a group meeting at theater 2 can conduct bi-directional, live video conferencing with one or more other persons located at, for example, a content origination location.

The live video feed(s) 95 and microphone(s) 90 can also be used to monitor the reactions of a test audience or focus group that is viewing an event, such as a film or an advertisement. The focus group can be monitored in real time at, for example, a content origination location such as a film studio or any other point, or the live video/audio signals can be stored at the live video/audio compression system 85 (or another location) for subsequent playback. Timing signals received from the store/forward server can also be recorded by live video/audio compression system 85 for correlating the captured audience reactions to the content that invoked the recorded reactions.

In one aspect of the present invention, one or more of the live video feeds 95 may employ IR or low light cameras for viewing the audience under low-light theater conditions during the projection of the content. In addition, the audience may provide feedback on the content, be provided additional information regarding the content, or interact with the content via wired devices at each seat or wireless feedback devices, such as cell phones or PDAs.

In a preferred embodiment, the content leaving content server 10 is strongly encrypted to discourage unauthorized interception and viewing or recording of the transmitted signal. A function of the store/forward server 75 is to remove the strong encryption prior to playout, and to preferably provide in its place encryption on the link between store/forward server 75 and the decryption and projection unit 105, thereby discouraging unauthorized recording of the content in theater 2. In other embodiments, decryption/projection system 105 may be implemented and configured for removing the strong encryption, thereby eliminating this function from store/forward server 75.

It will be appreciated by those skilled in the art that various types of digital content can be distributed using the present invention, and that DDN 1 may be arranged in a variety of configurations. That is, the embodiment depicted herein are not intended to be viewed in a limiting sense upon the scope and practice of these teachings. Although DDN 1 is discussed herein primarily in the context of distributing digital content, either pre-recorded or live, to theaters 2 for viewing, and providing a video teleconferencing functionality, this is done in order to illustrate, and not limit, the teachings of this invention.

Viewing pre-recorded content

Referring to FIG. 1, content server 10 receives pre-recorded digital content 5 from a content source, such as from a content server controlled by the owner/provider of DDN 1. Caching server 80 located in theater 2 is polled or scheduled for communicating with content server 10 for providing content to caching server 80. Content server 10 may operate to “push” content to the theater-located store/forward servers 75. Content is requested or “pulled” in other embodiments. Content can also be sent to theater 2 and ingested into the caching server or store/forward server 75 using high density media. At theater 2, the store/forward server 75 receives content, stores it for archival purposes and forwards the content to other components of the theater-located system, including decryption and projection system 105 and audio playback system 110.

Store and forward server 75 located in a theater may be uniquely designated, either automatically or by a system administrator, to wait until content is flagged for reception. Backchannel 4, in some instances very small (e.g., a 56 kbps dedicated dialup), is preferably provided so that various aspects of theater 2, including store/forward server 75, can be monitored, controlled, and updated with new scheduling scripts.

According to transmission scheduling software that is itself distributed to theaters 2, content is pushed to store/forward server 75 of the DDN 1. The time for displaying a film can be coordinated by, for example, a local marketing manager using an internal Extranet, or by any other suitable means.

At the beginning of an event, such as a film showing, theater automation system 100 identifies, via backchannel 4, the physical parameters of theater 2 and parameters of the equipment used for playback via a hardware abstraction layer present in all of the equipment. The execution of an event is described and specified by a collection of nested scripts, encapsulated into an overall event script that controls the event execution. The event script may be nested into a script that is executed by store/forward server 75 for controlling theater 2 for a given period of time, such as a day or a week. The event script is typically associated with real time so that the scheduled events can be executed at the proper time and in the proper sequence. All other scripts can be time-independent.

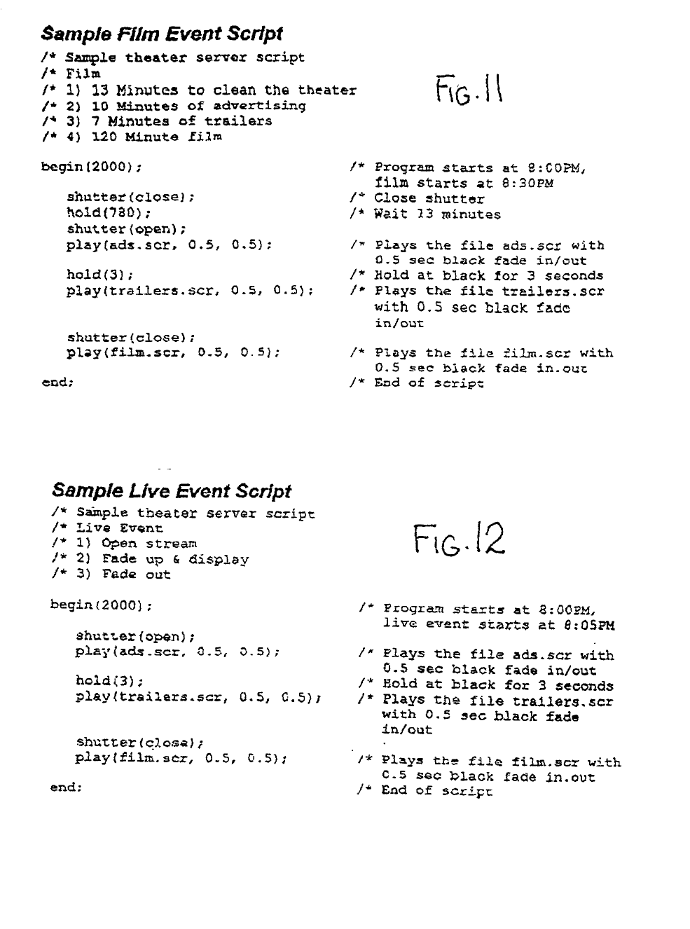

Any of a number of suitable scripting languages may be employed. Examples of film and live event script are shown in FIGS. 11 and 12, respectively. The scripts are preferably distributed to store/forward server 75 as metadata along with the content that is to be viewed in theater 2.

In a presently preferred, but not limiting embodiment, an event begins with an advertising program containing still frames, video footage, and audio. The use of curtains, lights, and other cinema controls depends on a particular theater's facility. The script specifying the order and duration of the advertisements is sent to caching server 80 and forwarded to store/forward server 75 for execution. Store and forward server 75 may default to, by example, 29.97 fps, or to the local television standard frame rate. All event duration calculations will be based on the operational frame rate. Store and forward server 75 preferably operates to mix at least two stereo audio streams. As the advertising program commences, a background audio stream is played using audio system 110. Audio files can also be linked to advertising content or, in the case of video content, embedded in the video file. The duration of the audio file event is set to match what is specified in the program script. Error checking may be provided on the script when it is generated and before it is loaded to store/forward server 75.

Content with attached audio may play over background music or preempt background music entirely. All audio transitions may be performed using a level fade. Store and forward server 75 preferably supports common audio formats. Video material (i.e., non-still frames) shown during the advertising program is recorded or scaled to the default rate before entering store/forward server 75. In addition, all material is preferably scaled to the standard resolution of digital projector 105 prior to entering store/forward server 75. The advertisements are preferably scaled to display properly with anamorphic and non-anamorphic films, depending on the main event content's needs. In the preferred embodiment, DDN 1 uses the current native resolution of a Digital Light Processing (DLP) chip that forms a part of digital projection system 105.

In operation, the advertising program can be scripted to loop or to continuously fill the time between the end of an event (e.g., feature film) and the beginning of another event (e.g., the display of a movie trailer). The theater house lights are preferably dimmed to an appropriate level by theater automation system 100, and the trailer program starts. The trailer sequence is preferably treated like the advertising program discussed above. Trailers are encoded as described above so that there is no frame rate difference between advertising and trailer programs. Once the trailer program then finishes, the theater lights are then dimmed to their final level and any necessary adjustments are performed by theater automation system 110 in preparation for the playback of the pre-recorded film content 5. Film content 5 starts, appending multiple files in real time (using cuts or timed fades) for display. When the film is finished the next program or event starts.

A standard program audio used by DDN 1 is 5.1 digital audio. The system format can work in combination with Digital Theater System (DTS) or other audio formats such as Dolby E and Sony's SDDS, including multiple channel, uncompressed audio formats.

Some predetermined amount of time is preferably allotted for allowing cleaning of theater 2. The allotted time can be used as a buffer in case there are timing errors during the playback of the previous event script sequence or other timing delay circumstances. Caching server 80 is coupled to store/forward server 75 logs all aberrations such as timing delays.

An example of a typical prerecorded film event script is shown in FIG. 11. Nested scripts, as explained above, are used to control the entire event execution process. DDN 1 also preferably has some manual system function incorporated therein so that the timing of events (e.g., film showings) can be modified. For example, a theater manager may manually control caching server 80 to delay the showing of a film (i.e., override or modify an event script). Preferably, manual control inputs will be flagged, monitored, and analyzed for system status purposes.

Viewing a live event

In an aspect of the present invention, live events may be coordinated by a local marketing manager via an internal Extranet. The operational frame rate for the live event is preferably matched to the local television standard and switched at the beginning of the event. All content, including the live event and any advertising prior to it, is mixed into the stream broadcast style. An ATSC decoder 82 decodes and passes the live content stream through AV matrix 84 to projector system 105 that displays the digital content. For this scenario, DDN 1 is configured to stream high-bandwidth, high-definition video to each theater 2. Backchannel 4, e.g., approximately 56 kbps, is used to monitor network and equipment health located at theater 2. An exemplary, simplified e live event script is shown in FIG. 12.

Video teleconferencing

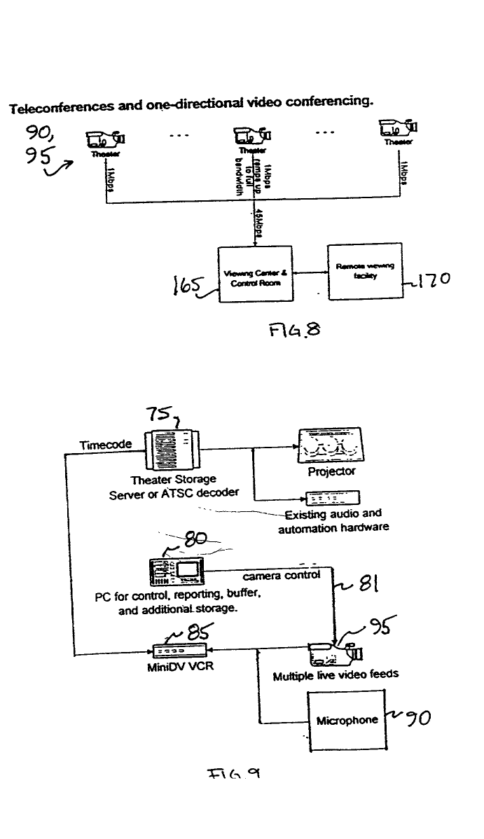

In another aspect hereof, and referring to FIG. 8, each theater 2 may be provided with live feed video camera system 95 for video teleconferencing. Teleconferences may be coordinated by local or regional marketing managers via an internal Extranet. An appropriate amount of bandwidth of DDN 1 is preferably made available for the transmission of the teleconference content. The frame rate is preferably matched to the local television standard and switched at the beginning of the event, and proceeds as a one-to-many and many-to-many video teleconferencing or broadcast application. Before the event begins a check is made to ensure that video cameras 95 at each theater 2 are functioning and the allotted bandwidth is appropriate for each one.

The teleconferencing event begins, for example, with either a one-to-many teleconference or a videotape being played. If a video is played, it is mixed, broadcast style, into the video stream. When the videotaped segment is over, a moderator can open the discussion up to each location. Ideally, an aggregate backchannel 4 of approximately 10 Mbps can be maintained from each content origination point. In this aspect, it is desirable to provide a viewing center and a control room 165, at least one remote viewing facility 170 and/or stream the content to the Internet.

Marketing Research Groups

Marketing research groups, including focus groups for gathering marketing data, may be assembled and coordinated by regional marketing managers via the internal Extranet. The entire bandwidth of DDN 1 may be made available, if necessary, for the transmission of the focus group. The frame rate is determined and set at the beginning of the event.

The marketing research group application has a unique set of features. For example, there are low-light-level video cameras 95, or IR cameras, mounted in the theater 2 in such a way as to cover the entire audience (for example, either one camera 95 with a fisheye lens or four cameras 95 positioned in each quadrant of the theater auditorium or multiple cameras with remote pan, tilt, and zoom functionality). There are also one or more of the microphones 90 that record audience reaction, but, preferably, filter out the program material. This information, which may be suitably compressed by the optional compression unit 85, can be recorded on media such as, standard definition Mini-DV tapes by a MiniDV VCR 85 (see FIG. 9) or other recording mechanisms and/or transmitted over backchannel 4, in association with time codes output from the store/forward server 75 (or an ATSC decoder), in time code synch with a projected film.

The start of a marketing research group event is similar to that of a film. Store and forward server 75 has the option of showing trailers and other filler before the event begins. When the film starts, the output of each camera 95 may be multiplexed and sent back via the backchannel 4 to an optional viewing area (165, 170) for interested parties, such as studio executives, directors, producers, etc. to view. Time code information is preferably also sent to the optional viewing area to synchronize viewing of audience reaction to the distributed content. When audience reaction is recorded, analysis of the gathered market research data may be performed at a later date.

The foregoing description provides an overview of the presently preferred embodiment of DDN 1. Further details are now provided as to various specific and exemplary implementations of DDN 1.

A 45 Mbps (DS3) connection to an uplink provider, that provides and maintains the uplink equipment 25, can be installed as part of the transport segment 65. The bandwidth of DDN 1 can be expanded by leasing or renting, on an as-needed basis, an additional satellite transponder.

A wide-area terrestrial data communications network may also be employed as part of the transport segment 65 to provide the content to various theaters 2. One benefit of using the terrestrial network is that the available bandwidth can be readily increased to any desired amount for providing streaming video and audio of very high quality.

Another alternative of the present invention includes using a physical distribution network. That is, all distributed data and content are transferred manually using a portable recording medium (e.g., a DVD) and human interaction.

In the preferred embodiment, all of the applications for the network system are preferably Web browser-based. Feedback is gathered from the Web, comprising part of transport segment 65, and through wireless devices (an extension of the Web). Web sites are preferably timed or synchronized to the flow of content so that theater goers can access, in theater 2, details about the scenes currently being displayed in theater 2 and pages are accessible via the Web for viewers to comment about the films. In addition, Web boards (commonly called forums), chats, and e-mail are preferably also made available.

Viewers in theater 2 can be linked to backchannel 4 that can include the Internet. Viewers can be provided with handheld wireless devices for generating Web queries. In a presently preferred embodiment DDN 1 supports wireless viewer feedback mechanisms such as WAP enabled devices, iMode, wireless Ethernet, and Bluetooth. Viewers may be enabled to enter queries and the like using personal digital assistants (PDAs) and other portable wireless devices. Small displays can be used by viewers for viewing responses, Web pages and the like. Content server 10, or another server, can be used for interacting with the viewers in the various theaters 2. An optional kiosk may also be employed at or as a point of sale (POS) for enabling users to register comments and reviews concerning a film that they have viewed, and to couple these comments and reviews via the backchannel 4 to the content origination location, or to some other location(s). The output of the optional POS kiosk can be coupled to the Internet for the purpose of communicating viewer provided comments and reviews to a content origination (or other) location. Wired or wireless devices may also optionally be built in to theater seats to allow viewers to register feedback, comments and reviews.

It can be appreciated that DDN 1 described thus far supports the distribution of a variety of digital video resolutions, and furthermore provides an ability to implement bi-directional, interactive teleconferencing to and from each theater 2. An ability to stream feeds into each theater 2 is also provided, enabling live events to be simultaneously viewed in each theater 2. DDN 1 also provides an ability to store content, a capability to forward content to various locations, a capability to provide for program and auditorium management, including scheduling, monitoring and reporting of DDN 1 events and status. Screen management software can be used to allow regional managers to (1) program screens from a pool of available content, and (2) provide teaser trailers and advertisements on theater screens or on plasma screens, in theater lobbies. Advertising management software can be employed to manage advertisement placement on screens. An ability to pull content directly from the store/forward servers is also provided, as is an ability to support a fade or a cut between programs that provides a mechanism to adjust credits or certain scenes for particular markets. A capability is also provided to support text overlays or character generators such that alternate subtitles can be chosen by the theater management software or metadata included with the content. DDN 1 is capable of managing video from 25 Mbps (and lower) through at least 15 Gbps, and furthermore has an ability to synchronize program material to time code or genlock it to any other node on the network. An ability is provided to support alternate soundtracks that can be selected by the theater management software or metadata included with the distributed content. Also provided is an ability to support most common audio formats (e.g., mono, stereo, Dolby stereo, 5.1, 7.1, 10.2, etc.).

In another aspect hereof, when the final cut of a film is made it is then ready for digitization, compression, encryption, and transmission. The (post-filming) digitization step is not necessary for digitally recorded films. Video encoding and decoding for the store and forward content may be handled by the video servers, such as content server 10, and store and forward (video) server 75. Live content can optionally be compressed prior to transmission using, for example, MPEG compression technology or any other suitably applicable compression technology.

The digital audio system may also use encrypted audio, and the bandwidth thereof may be limited to 1 Mbs or less. It will be appreciated by those skilled in the art that the transmitted audio signal could be uncompressed and the bandwidth used thereby could be, for example, 1.8 Mbs for 12 channels of uncompressed audio.

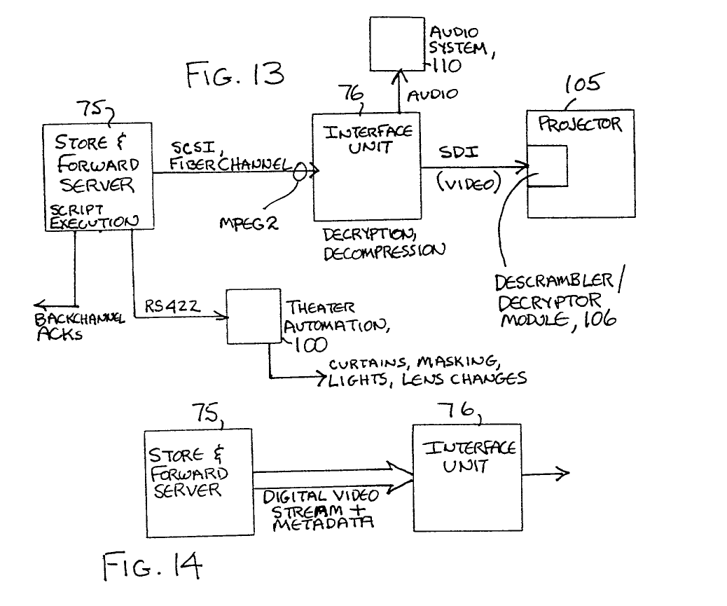

In a preferred embodiment, content within DDN 1 that is used for exhibition is encrypted. Decryption may be handled by store/forward server 75 and/or by digital projector 105, if the projector is so enabled. In another embodiment described below in reference to FIGS. 13 and 14, the decryption is accomplished by an intermediate interface unit 76 that is disposed between store/forward server 75 and digital projection system 105. Preferably any decryption scheme that is selected for use may be up-graded as desired either by firmware or hardware. If programming is distributed on DVD-ROM, each DVD is preferably encrypted and password protected, and is also serialized. Also, watermarks may be used on a per screen basis, so that any bootleg (i.e., unauthorized) copy of a program or film content can be identified by place and time.

In the preferred embodiment of DDN 1, occurrences of digital content transfers to each theater 2 are logged. Each program that is played is also logged in theater 2 and subsequently reported using backchannel 4. Storage needs are constantly assessed using reports from the Extranet system to manage and maintain sufficient storage capacity on the caching server 80, as well as on store/forward server 75. Caching server 80 preferably employs a RAID 0+1 scheme of mass storage, though additional or alternative mass storage formats are within the scope of the invention. Bandwidth usage is also preferably monitored and reported, which can be an important consideration for live event planning, as well as for scheduling the delivery of content to the theaters. The health of DDN 1 (including network latency and integrity) is monitored in real time using, as one suitable example, a Novell™ Managewise software package. Alarms are set if a server does not respond to command and control input from the DDN 1 broadcast booth 50. It is desirable that each component of DDN 1 be SNMP compatible. Additional device monitoring and control can be performed by the scheduling and monitoring software included as part of DDN 1.

In the preferred embodiment all interactions within the DDN 1 are handled through an internal Extranet. The Extranet is a browser-based application that may manage the following exemplary tasks: (1) scheduling of content downloads for each theater 2, as well as live events over the satellite 30 or terrestrial network; (2) taking orders from theater representatives and scheduling for duplication of films; (3) command and control software that enables real-time monitoring and reporting on the satellite 30 network and/or on the terrestrial network; (4) command dial-up access for those theaters 2 with caching server 80 that are not connected to a network enabling them to report their status on a preferably schedule; (5) report software for marketing and businesses; (6) individually addressable screens that allow screen management software to place appropriate programming on each screen in theaters, as well as in the theater lobbies; and (7) screen management software that takes into account the available bandwidth with regard to all download requests and network requirements, including scheduled live events, to schedule available time to download programs.

Control and scheduling software that runs on the internal Extranet may perform the exemplary tasks and functions of providing (1) an ability to regulate and restrict the allowed viewing only to theater and times authorized by a global administrator; (2) an ability to rotate encryption keys based on the chosen encryption technology; (3) an ability to modify the transmission schedule; (4) an ability to monitor the operational status and health of the DDN 1; (5) an ability to log and confirm actions or group of actions by the theater equipment; and (6) an ability to allow each theater region to log ticket sales and attendance information.

The digital cinema equipment in theater 2 may support, inter alia, the exemplary functions of (1) the management of theater equipment, such as lighting and curtains; (2) the program status for each screen and any lobby monitors; (3) the assessment of ticket sales and actual attendance for each event; and (4) the scheduling and schedule reporting for film showings and other relevant events to Internet movie web sites comprising transport segment 65. Additionally, theater store/forward server 75 provides important operational control functions of the distribution network for each theater 2. Each store/forward server 75 preferably contains sufficient storage capacity and has sufficient bandwidth to support multiple (e.g., 4 digital projectors) digital projectors 105 and associated screens in each theater 2 (e.g., 45 Mpbs×4 projectors=180 Mbps plus up to 10 Mbps per (optional) preview screen in the theater lobby), as well as hot swappable RAID 0+1 disk arrays capable of holding four films (e.g., 40 G per film×4 films=160 G) plus any promotional material (e.g., video advertisements and trailers and (optional) lobby kiosk material). One device suitable for implementing store/forward server 75 is a QuBit™ server available from QuVIS, Inc. Additionally, there are suitable servers available from other manufacturers such as Grass Valley, Avica, EVS, and Technicolor Digital Cinema.

Projector system 105 preferably handled 24 hertz, as well as other possible frame rates. Examples of suitable projectors 105 that are currently available include, but are not limited to, Texas Instruments Digital Light Processing™ (DPL) projectors, and Hughes-JVC's Direct-Drive Image Light Amplifier™ (D-ILA) projectors.

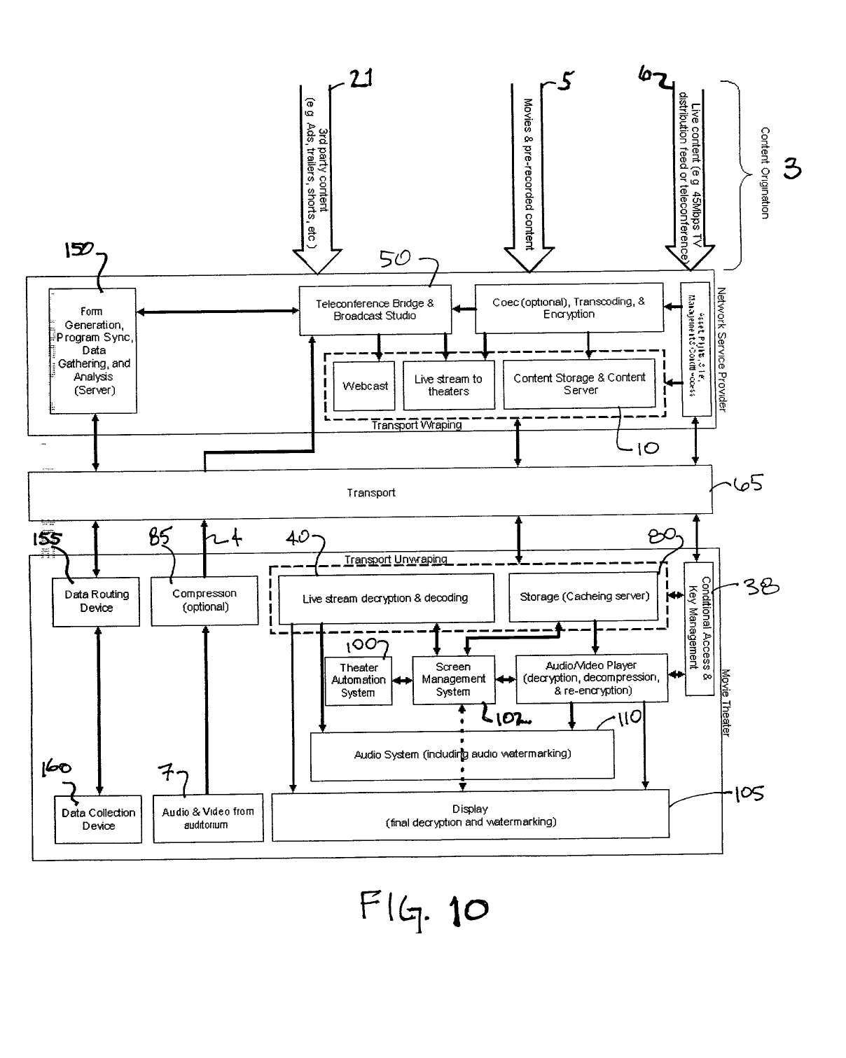

In another aspect of the present teachings, a form generation capability is provided by DDN 1 as shown in FIG. 10. Forms, questionnaires, coupons, vouchers, or other information can be transmitted from a remote location form generator 150 to a data collection device 160 at theater 2 via transport mechanism 65 and data routing device 155. In another embodiment, the forms, questionnaires, coupons, vouchers, or other information can be locally transmitted from screen management system 102 to data collection device 160. Data collection device 160 can be a PDA, mobile telephone, portable computer, pager, or other device configured to receive the communication of the forms, etc. Data related to the transmitted the forms and provided in response thereto is transmitted back to form generator 150 via transport mechanism 65 utilizing the communication links employed therein.

Referring to FIG. 2, pre-recorded content is content that has been entirely gathered before an exhibition. To enable the broadcast of content at high speed (currently, approximately 40 Mbps), DDN 1 is preferably configured to use windows of off-peak satellite time. Compressed files are sent from the central content server 10 to each theater server 75 at an off-peak time. Each theater 2 with satellite equipment preferably has a permanent connection to the Internet via a dedicated Public Owned Telephone System (POTS) dial-up line or other suitable connection such as DSL, Cable, or T1 connection. This enables DDN 1 to ensure that data packets are arriving at each theater 2. It also enables the reports on health and up-load status to occur on a periodic basis. Some theaters 2 may not be located in an area that is practical for satellite installation, such as in certain urban areas or where zoning laws prevent the use of satellite antennas. In these situations, a high speed land line connection such as, for example, a terrestrial DS3 connection can be employed. Content broadcasts are coordinated on both the terrestrial and satellite networks. In the event that a theater 2 has a DS3 connection, there is no need for the POTS line as the system health and status reports may be uploaded via the DS3 network.

Referring to FIG. 3, if live content is not available via a satellite as part of transport segment 65, a commercial free, third party distribution feed 21 can be routed to the uplink center via a terrestrial network including terrestrial network router 120. Any necessary conversion to a format native to projector system 105 can be performed by, for example, ATSC encoder 130. The feed is then routed over DDN 1 via satellite 30 and via the terrestrial network through terrestrial network router 125 for those theaters 2 that do not support satellite downlink capability.

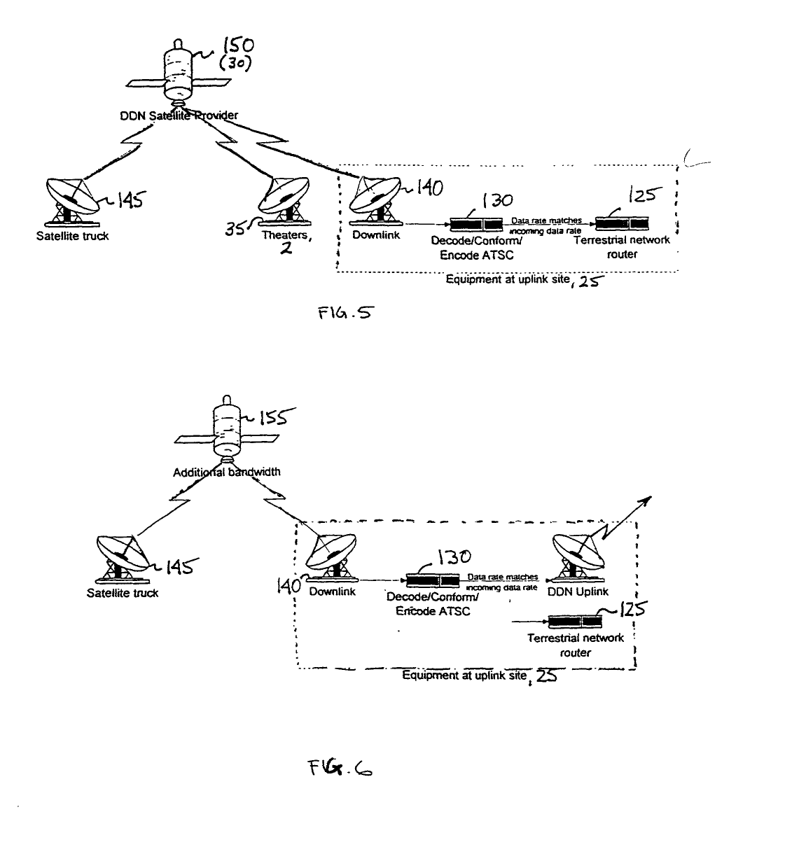

Referring to FIG. 4, live content may be made available via the satellite network forming part of transport segment 65 shown in FIG. 1. In this situation, the uplink provider receives a commercial-free distribution feed 21 at one of their dishes 140 from a broadcaster's satellite 135 or a terrestrial network, performs any necessary video conversion, and uplinks the live feed content to the DDN 1 using, for example, the ATSC encoder 130. This content data stream is also fed to those theaters 2 that are only accessible via the terrestrial network (e.g., the DS3 network) through the terrestrial network router 125.

Referring to FIG. 5, in certain cases live events may be produced by the DDN 1 owner/provider or by one of its affiliates/partners. In this case a live event is directly digitally distributed to theaters 2 from a satellite truck 145 on the premises of the live event. Satellite truck 145 preferably has high definition capabilities and is equipped with a high definition or alternate encoder capable of generating the native formats of projector system 105. A downlink antenna 140 at an uplink site can also receive the live feed, convert the received content using a suitable high definition or alternate decoder 130, and provide the live content in a rate matched feed to the terrestrial network via the terrestrial network router 125.

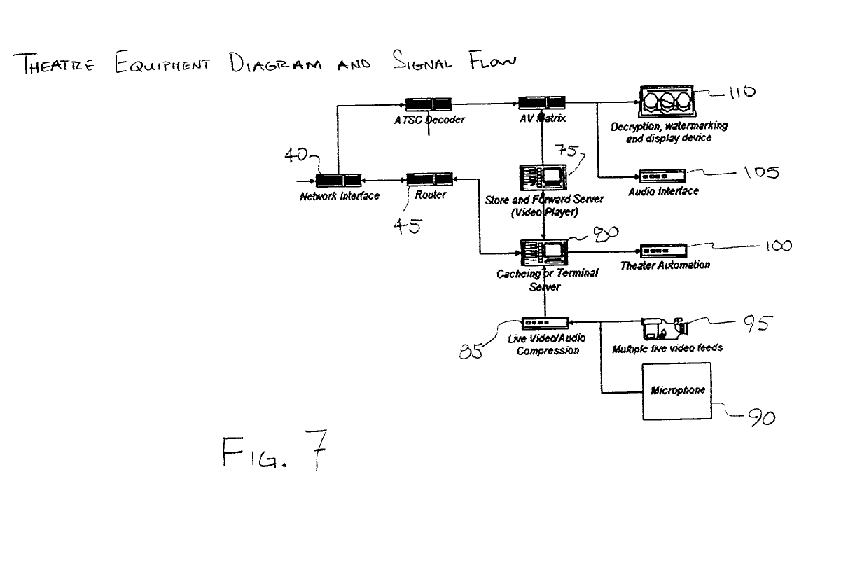

Referring to FIG. 6, when the appropriate high definition or alternate equipment is not available, or the event is produced in standard definition, the digital content feed can be conformed through the uplink provider's hardware. The live feed is sent via a satellite 155 or terrestrial network comprising transport segment 65 to uplink 25. At uplink 25 the content is converted to a format appropriate for projector system 105, and is further uplinked to theater 2. Again, terrestrial networks can be used as part of transport segment 65 to facilitate delivery of content to theatres not equipped to receive satellite transmissions using terrestrial router 125.

As previously stated the content leaving content server 5 is strongly encrypted to discourage unauthorized interception and viewing or recording of the transmitted signal, and the store/forward server 75 decrypts the content prior to the display thereof. It was also stated that the store/forward server 75 may provide a lighter encryption (e.g., data scrambling). It should be appreciated that other types of encryption can be used on the link between store/forward server 75 and projection system 105 without departing from the scope of the present invention.

As such, FIG. 13 is a block diagram of a further embodiment of this invention, wherein an interface unit 76 is disposed between store/forward server 75 and digital projection system 105. In this embodiment the distributed content is stored in the received encrypted form in store/forward server 75 and subsequently transmitted, still encrypted (and compressed) to interface unit 76. The data may be in MPEG2 format, and can be transmitted over a SCSI or a fiber channel.

Referring also to FIG. 14, which shows a high level block diagram that includes the digital content data stream output from store/forward server 75 to interface unit 76, it can be seen that the digital content stream includes embedded metadata for configuring the interface unit 76.

In the embodiment depicted in FIGS. 13 and 14 interface unit 76 operates to decompress and decrypt the received data stream, and to provide the decompressed and lightly encrypted or scrambled data stream to the projector 105. In this case, an interface module 106 is installed in digital projector system 105 for decrypting or descrambling the content data stream before projecting same on the screen for the viewers.

Interface module 76 may include a 14-bit video codec to implement video decompression and processing. The use of the 14-bit or greater codec is preferred over a conventional 8-bit MPEG or similar codec in order to reduce the amount of color error over that experienced with the conventional 8-bit MPEG codec (typically about 2% color error when compared with uncompressed NTSC or PAL color coding, error is greater when compared to film). In a presently preferred embodiment, the content is not compressed, and instead is transmitted from content server 10 to theater 2 and digital projector system 105 in an uncompressed format.

It should be appreciated that it is desirable, but not necessary, to integrate the functionality of store/forward server 75 and interface unit 76 so as to arrive at the configuration depicted in FIG. 1. It is also desirable, but not necessary, to integrate the functionality of caching server 80 with store/forward server 75; and high definition or alternate video decoder 82, AV matrix 84 and store/forward server 75.

While described above in the context of presently preferred embodiments, those skilled in the art should realize that various modifications to these teachings can be made, and that the modified system will still fall within the scope of these teachings. As an example, the backchannel 4 can be used to support interactive gaming by audience members at the plurality of theaters 2. Further by example, these teachings are not intended to be limited to any of the various data formats, data rates, specific numbers of components, or to any of the specific examples of suitable system components that were disclosed above.

What is claimed is:

1. A digital content distribution and viewing system, comprising:
a source of at least one of pre-recorded or live digital content;
a transport mechanism for distributing said digital content to a plurality of theater locations where said digital content can be viewed by an audience; and
at said plurality of theater locations, a video camera for monitoring and generating a monitoring video signal of the audience under low-light conditions.

2. A digital content distribution and viewing system according to claim 1 comprising a backchannel for transporting said monitoring video signal to one or more locations.

3. A system as in claim 2, wherein said backchannel comprises the Internet.

4. A digital content distribution and viewing system according to claim 1 further comprising a store and forward server for receiving said digital content and at least one script for controlling an action of said theater, the action being associated with the viewing of said digital content.

5. A digital content distribution and viewing system according to claim 4 wherein the backchannel is used to transport a log that is descriptive of said action to a remote site.

6. A digital content distribution and viewing system according to claim 1 wherein said monitoring video signal is combined with a time stamp associated with said digital content for synchronizing said monitoring video signal with said digital content distributed to said theater.

7. A digital content distribution and viewing system according to claim 1 wherein said video camera comprises an infrared (IR) camera.

8. A digital content distribution and viewing system according to claim 1 wherein said digital content is selected from the group consisting of pre-record content, live content, and video games

9. A digital content distribution and viewing system according to claim 1 further comprising:
a form generator for generating a form, said generated form being transported to at least one of said plurality of theater locations and associated with said digital content; and
a data collection device for receiving said generated form at said at least one theater location.

10. A digital content distribution and viewing system according to claim 9 wherein said data collection device receives a user input signal for registering a user response to said generated form.

11. A digital content distribution and viewing system according to claim 9 wherein said data collection device content is selected from the group consisting of a mobile phone, a PDA (personal digital assistant), a pager, and a portable computer.

12. A digital content distribution and viewing system, comprising:
a source of at least one of pre-recorded or live digital content;
a transport mechanism for distributing said digital content to a plurality of theater locations in an encrypted format using a first encryption technique, said theater locations having theater equipment enabling said digital content to be viewed by an audience; and
a store and forward server at said theater locations for receiving and operatively decrypting said digital content, and for encrypting said digital content using a second encryption technique before transmitting said digital content to an input of a digital projection system coupled to an output of said store and forward server.

13. A digital content distribution and viewing system, comprising:
a source of at least one of pre-recorded or live digital content;
a transport mechanism for distributing said digital content to a plurality of theater locations in an encrypted format using a first encryption technique, said theater locations enabling said digital content to be viewed by an audience with theater equipment;
at said theater locations, a store and forward server for receiving said digital content, said store and forward server having an output coupled to an input of a digital projection system; and
an interface module, interposed between the output of said store and forward server and the input of said digital projection system, operatively decrypting said digital content and encrypting said digital content using a second encryption technique before transmitting said digital content to the input of said digital projection system.
